(19) United States
(12) Patent Application Publication
(10) Pub. No.: US 2021/0206927 A1
(43) Pub. Date: Jul. 8, 2021

(54) Acrylic Resin Film For Retroreflective Sheet And Retroreflective Sheet

(71) Applicant: Mitsubishi Chemical Corporation, Tokyo (JP)

(72) Inventor: Junichi Abe, Tokyo (JP)

(73) Assignee: Mitsubishi Chemical Corporation, Tokyo (JP)

(21) Appl. No.: 17/152,323

(22) Filed: Jan. 19, 2021

Related U.S. Application Data
(63) Continuation of application No. PCT/JP2019/027301, filed on Jul. 10, 2019.

(30) Foreign Application Priority Data
Jul. 23, 2018 (JP) 2018-137613
Feb. 20, 2019 (JP) 2019-028184

(51) Int. Cl. C08J 5/18; C08L 33/10; C08K 5/00; C09K 11/06; G02B 5/128

(52) U.S. Cl. CPC C08J 5/18; C08L 33/10; G02B 5/128; C09K 11/06; C08K 5/0041; C08K 5/005

(57) ABSTRACT

Provided are an acrylic resin film for a retroreflective sheet having a fluorescent color and a good visibility and a weather resistance, and a retroreflective sheet having a skin material having a fluorescent color and good visibility and weather resistance. An acrylic resin film for a retroreflective sheet of the present invention includes an acrylic resin composition that contains an acrylic resin (A), a fluorescent dye (B), and at least one colorant (C) selected from the group consisting of pigments and dyes (here, a fluorescent dye is excluded), in which a content of the colorant (C) is 1.0 to 4.0 parts by mass with respect to 100 parts by mass of the acrylic resin (A).

This application is a continuation application of International Application No. PCT/JP2019/027301, filed on Jul. 10, 2019, which claims the benefit of priority of the prior Japanese Patent Application No. 2018-137613, filed Jul. 23, 2018 and Japanese Patent Application No. 2019-028184, filed Feb. 20, 2019, the contents of which are incorporated herein by reference.

### TECHNICAL FIELD

The present invention relates to an acrylic resin film for a retroreflective sheet and a retroreflective sheet.

### BACKGROUND ART

A retroreflective sheet that reflects incident light toward a light source has been well known, and is used in various fields by taking advantage of retroreflective properties thereof and excellent visibility in dark places. For example, signs using the retroreflective sheet, such as a road signs and a construction sign have excellent properties of reflecting light from a light source of headlights of a vehicle traveling in a dark place such as at night toward the light source, that is, toward the traveling vehicle, providing excellent visibility to a driver of the vehicle who is a viewer of the sign, and enabling clear information transmission.

As the retroreflective sheet, an enclosed lens type retroreflective sheet, a capsule type retroreflective sheet, a prism type retroreflective sheet, and the like are known. In particular, the prism type retroreflective sheet (for example, a triangular pyramidal type cube corner retroreflective sheet) has an excellent retroreflective property, and thus a use thereof is increasing year by year.

By using a colored acrylic resin film as a skin material of the retroreflective sheet used for such a road sign, a construction sign, and the like, it is possible to impart characteristics such as weather resistance and visibility to the retroreflective sheet. In addition, in order to further improve the visibility of the road sign and the like, it is required to impart not only a retroreflective property but also a fluorescent color to the sign.

The following films are disclosed as films having the fluorescent color.

(1) A fluorescent yellow-green film obtained by molding an acrylic resin composition that contains: a (meth)acrylic resin containing acrylic rubber particles: a triazine compound as an ultraviolet absorber; and a thioxanthene compound as a dye (Patent Literature 1).

(2) A fluorescent yellow-green film obtained by molding an acrylic resin composition that contains a (meth)acrylic resin, polycarbonate, and a thioxanthene compound (Patent Literature 2).

(3) A fluorescent acrylic resin sheet containing an acrylic resin, an acrylic rubber component having a multi-layer structure, and a fluorescent dye, and having a top yield point stress of less than 12 MPa (Patent Literature 3).

(4) A film containing polycarbonate, a fluorescent dye, and a white pigment (Patent Literature 4).

(5) A retroreflective information display sheet and a method for manufacturing the same (Patent Literature 5).

### CITATION LIST

### Patent Literature

[Patent Literature 1]
Japanese Unexamined Patent Application, First Publication No. 2011-32328
[Patent Literature 2]
Japanese Unexamined Patent Application, First Publication No. 2011-52157
[Patent Literature 3]
Japanese Unexamined Patent Application, First Publication No. 2014-224209
[Patent Literature 4]
Japanese Unexamined Patent Application, First Publication No. 2015-147915
[Patent Literature 5]
Japanese Unexamined Patent Application, First Publication No. Hei 10-105091

### SUMMARY OF INVENTION

### Technical Problem

However, the films having the fluorescent colors in (1) to (4) have insufficient weather resistance. Therefore, in a case where the films having the fluorescent colors in (1) to (4) are used as the skin material of the retroreflective sheet, a color of the skin material is lost when the film is used outdoors for a long time, and the visibility deteriorates.

In addition, the retroreflective sheet in (5) is not high in lightness (L*) and is inferior in visibility. Also, a structure of the sheet is complicated. Therefore, handleability is inferior, and a fluorescent agent and a pigment are present in separate layers. Accordingly, there was a defect that it was not possible to interact.

An object of the present invention is to provide an acrylic resin film for a retroreflective sheet, which has a fluorescent color and has good visibility and weather resistance. The present invention also provides a retroreflective sheet having a skin material that has a fluorescent color and has good visibility and weather resistance.

### Solution to Problem

The present invention has the following aspects.

[1] An acrylic resin film for a retroreflective sheet, including:

an acrylic resin composition which contains;
an acrylic resin (A),
a fluorescent dye (B), and
at least one colorant (C) selected from the group consisting of pigments and dyes (here, a fluorescent dye is excluded),

in which a content of the colorant (C) is 1.0 to 4.0 parts by mass with respect to 100 parts by mass of the acrylic resin (A).

[2] The acrylic resin film for a retroreflective sheet according to [1],

in which the fluorescent dye (B) includes at least one selected from the group consisting of a thioxanthene dye, a thioindigoid dye, an anthraquinone dye, a benzoxazole coumarin dye, a perylene dye, a peryleneimide dye, a benzopyran dye, an anthracene dye, and an isoquinoline dye.

[3] The acrylic resin film for a retroreflective sheet according to [1] or [2],

in which a total of a content of the fluorescent dye (B) contained in the acrylic resin composition and the content of the colorant (C) contained in the acrylic resin composition is 1.5 to 10.0 parts by mass, with respect to 100 parts by mass of the acrylic resin (A).

[4] The acrylic resin film for a retroreflective sheet according to any one of [1] to [3],

in which the acrylic resin composition further contains a light stabilizer (D).

[5] The acrylic resin film for a retroreflective sheet according to [4], in which a content of the light stabilizer (D) contained in the acrylic resin composition is 0.1 to 3.0 parts by mass with respect to 100 parts by mass of the acrylic resin (A).

[6] The acrylic resin film for a retroreflective sheet according to any one of [1] to [5],

in which the fluorescent dye (B) contains one or both of a yellow fluorescent dye and a red fluorescent dye.

[7] The acrylic resin film for a retroreflective sheet according to any one of [1] to [6],

in which a chromaticity coordinate (x, y) in an XYZ color system is within a range surrounded by four points of (0.583, 0.416), (0.535, 0.400), (0.642, 0.305), and (0.692, 0.309) (hereinafter, also referred to as a “range A1”).

[8] The acrylic resin film for a retroreflective sheet according to any one of [1] to [7],

in which a Y value in an XYZ color system is 10 to 40.

[9] The acrylic resin film for a retroreflective sheet according to any one of [1] to [8], including:

an acrylic resin composition in which the content of the colorant (C) contained in the acrylic resin composition is 1.1 to 2.5 parts by mass with respect to 100 parts by mass of the acrylic resin (A).

[10] The acrylic resin film for a retroreflective sheet according to any one of [1] to [9],

in which the acrylic resin film is a single layer film formed from the acrylic resin composition.

[11] A retroreflective sheet including:

the acrylic resin film for a retroreflective sheet according to any one of [1] to [10],

in which a chromaticity coordinate (x, y) in an XYZ color system is within the range A1.

[12] The retroreflective sheet according to [11], further including:

a retroreflective element layer,

in which the retroreflective element layer includes a spherical lens or a prism.

[13] An acrylic resin film for a retroreflective sheet, including:

an acrylic resin composition which contains;
an acrylic resin (A),
a fluorescent dye (B), and
at least one colorant (C) selected from the group consisting of pigments and dyes (here, a fluorescent dye is excluded),

in which all of the fluorescent dye (B) and the colorant (C) are contained in a single layer.

### Advantageous Effects of Invention

An acrylic resin film for a retroreflective sheet of the present invention has a fluorescent color and has good visibility and weather resistance.

A skin material of a retroreflective sheet of the present invention has a fluorescent color and has good visibility and weather resistance.

### BRIEF DESCRIPTION OF DRAWINGS

FIG. 1 is a diagram showing a range A1 in a chromaticity coordinate (x, y) (specifically, an area surrounded by (0.583, 0.416), (0.535, 0.400), (0.642, 0.305), and (0.692, 0.309), by connecting each coordinate from the first (0.583, 0.416) in order with a straight line is the range A1).

FIG. 2 is a schematic sectional view showing an example of an enclosed lens type retroreflective sheet.

FIG. 3 is a schematic sectional view showing an example of a capsule type retroreflective sheet.

FIG. 4 is a schematic sectional view showing an example of a prism type retroreflective sheet.

FIG. 5 is a diagram showing chromaticity coordinates (x, y) of an acrylic resin film in examples.

FIG. 6 is a diagram showing chromaticity coordinates (x, y) of an acrylic resin film in examples.

FIG. 7 is a diagram showing chromaticity coordinates (x, y) of an acrylic resin film in examples.

### DESCRIPTION OF EMBODIMENTS

The definitions of the following terms apply throughout the present specification and claims.

“Tristimulus values X, Y, and Z and a chromaticity coordinate (x, y) in an XYZ color system” of an acrylic resin film are obtained as follows.

The acrylic resin film and a standard white plate overlap each other, and a spectral reflection spectrum is measured from the acrylic resin film side under conditions of 0° illumination for a reflection measurement, 45° circumferential light reception, standard light D65, and 10° field of view to determine the tristimulus values X, Y, and Z in the XYZ color system and determine the chromaticity coordinate (x, y) therefrom.

“Tristimulus values X, Y, and Z and a chromaticity coordinate (x, y) in the XYZ color system” of a retroreflective sheet are obtained as follows.

The retroreflective sheet and the standard white plate overlap each other, and a spectral reflection spectrum is measured from the acrylic resin film side of the retroreflective sheet under conditions of 0° illumination for a reflection measurement, 45° circumferential light reception, standard light D65, and 10° field of view to determine the tristimulus values X, Y, and Z in the XYZ color system and determine the chromaticity coordinate (x, y) therefrom.

The “standard white plate” is a plate showing an X value of 93.96, a Y value of 95.90, and a Z value of 113.05 in the XYZ color system, when measured under the conditions of 0° illumination for a reflection measurement, 45° circumferential light reception, standard light C, and 2° field of view.

A “gel content” is a value calculated by a formula below, by extracting a predetermined amount (mass before extraction) of an acrylic resin (A) in an acetone solvent under reflux, separating the treated liquid by centrifugation, drying an acetone-insoluble matter, and then measuring the mass (mass after extraction).

Gel content (%)=Mass after extraction (g)/Mass before extraction (g)×100

A “glass transition temperature” (hereinafter, also referred to as “Tg”) is a value calculated from a FOX formula using a value described in a polymer handbook [Polymer HandBook (J. Brandrup, Interscience, 1989)].

A “haze” is a value measured in accordance with JIS K 7136: 2000 (corresponding international standard ISO 14782: 1999).

“(Meth)acrylic” refers to “acrylic” or “methacrylic”.

A “molecular weight” is a standard polystyrene-equivalent value measured by a gel permeation chromatography (GPC) under the following GPC measurement conditions.

### <GPC Measurement Conditions>

Equipment used: HLC-8320 GPC system manufactured by Tosoh Corporation Column: 2 Columns of TSKgel Super HZM-H (product name, manufactured by Tosoh Corporation)

Eluent: Tetrahydrofuran

Column temperature: 40° C.

Detector: Differential refractive index (RI)

A “thickness” is a value measured with a thickness gauge.

In the present specification and claims, “to” indicating a numerical range means that numerical values noted before and after the “to” are included as a lower limit value and an upper limit value.

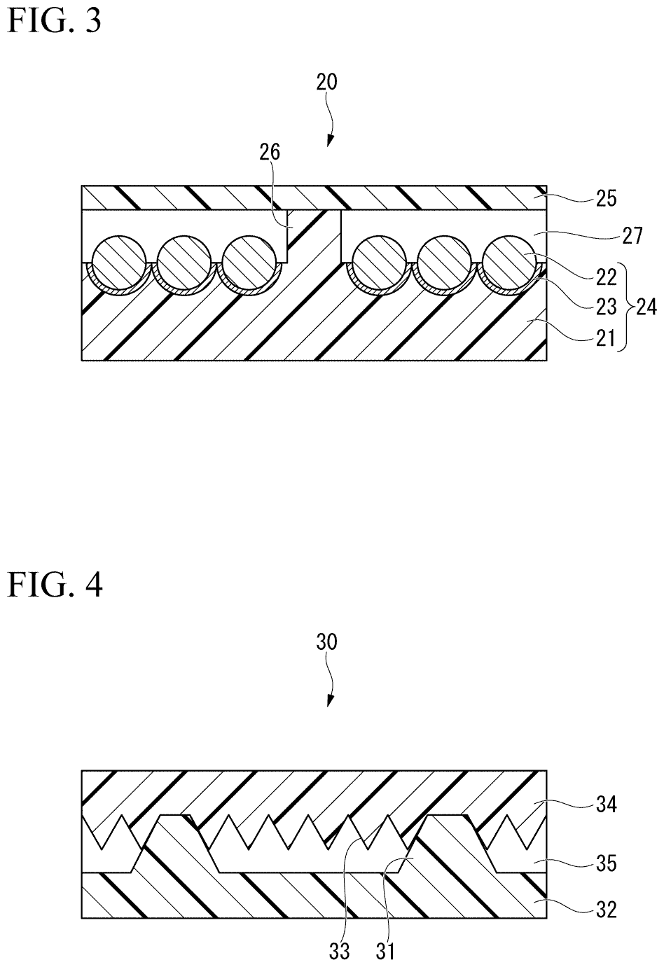

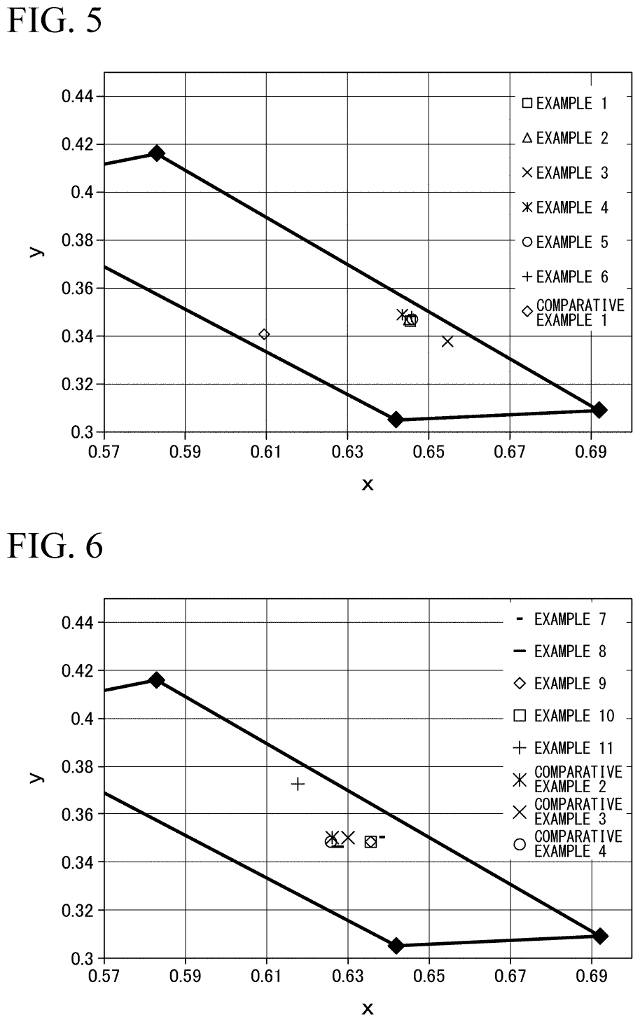

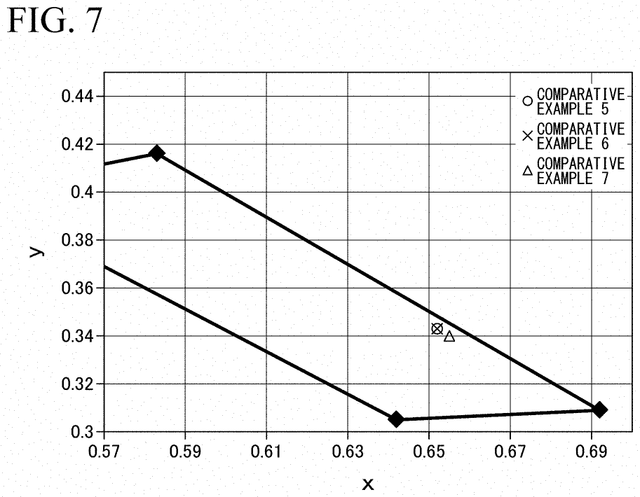

Dimensional ratios in FIGS. 3 to 6 are different from actual ones for convenience of explanation.

### <Acrylic Resin Composition>

An acrylic resin composition that can be used for an acrylic resin film for a retroreflective sheet of the present invention contains the acrylic resin (A), a fluorescent dye (B), and a colorant (C), and a content of the colorant (C) is 1.0 to 4.0 parts by mass with respect to 100 parts by mass of the acrylic resin (A).

The acrylic resin composition may further include a light stabilizer (D).

The acrylic resin composition contains components other than the acrylic resin (A), the fluorescent dye (B), the colorant (C), and the light stabilizer (D) (hereinafter, also referred to as “other components”), as needed, within the scope not impairing an effect of the present invention.

(Acrylic Resin (A))

The acrylic resin (A) is a polymer having a structural unit derived from (meth)acrylic acid ester.

The gel content of the acrylic resin (A) is preferably 0% to 60%, more preferably 0% to 50%, and still more preferably 0 to 40%, in that weather resistance and film moldability are excellent.

When the gel content is equal to or less than the above upper limit value, the weather resistance and the film moldability tend to be favorable.

The acrylic resin (A) preferably contains one or both of a rubber-containing polymer (A1) and a thermoplastic polymer (A2), and more preferably contains the rubber-containing polymer (A1) and the thermoplastic polymer (A2).

Heat resistance and flexibility of the acrylic resin film can be easily adjusted by changing a ratio between the rubber-containing polymer (A1) and the thermoplastic polymer (A2).

(Rubber-Containing Polymer (A1))

The rubber-containing polymer (A1) is a rubber-containing polymer obtained by polymerizing a monomer component (m12) containing alkyl methacrylate as an essential component, in the presence of a rubber polymer (A1a) obtained by polymerizing a monomer component (m11) containing alkyl acrylate and a polyfunctional monomer as essential components.

The rubber-containing polymer (A1) may also be a rubber-containing polymer obtained by polymerizing a monomer component (m13) containing alkyl acrylate, alkyl methacrylate, and a polyfunctional monomer as essential components, in the presence of the rubber polymer (A1a) obtained by polymerizing the monomer component (m11), and then polymerizing the monomer component (m12).

Examples of the alkyl acrylate, which is the essential component of the monomer component (m11), include methyl acrylate, ethyl acrylate, propyl acrylate, n-butyl acrylate, 2-ethylhexyl acrylate, and n-octyl acrylate. As the alkyl acrylate, n-butyl acrylate is preferable.

One kind of the alkyl acrylate may be used alone, or two or more kinds thereof may be used in combination.

Examples of the polyfunctional monomer which is the essential component of the monomer component (m11) include a crosslinkable monomer having two or more copolymerizable double bonds in one molecule.

Examples of the polyfunctional monomer include di(meth)alkylene glycol acrylate (such as ethylene glycol di(meth)acrylate, 1,3-butylene glycol di(meth)acrylate, 1,4-butylene glycol di(meth)acrylate, and propylene glycol di(meth)acrylate), polyvinylbenzene (such as divinylbenzene and trivinylbenzene), a cyanurate monomer having 2 or 3 alkenyl groups (such as triallyl cyanurate and triallyl isocyanurate), an alkenyl ester of α,β-unsaturated carboxylic acid (such as allyl methacrylate), an allyl ester of dicarboxylic acid, a methallyl ester of dicarboxylic acid, and a crotyl ester of dicarboxylic acid.

One kind of the polyfunctional monomer may be used alone, or two or more kinds thereof may be used in combination.

The monomer component (m11) may contain an alkyl methacrylate. Examples of the alkyl methacrylate include those having a linear or branched alkyl group.

Examples of the alkyl methacrylate include methyl methacrylate, ethyl methacrylate, propyl methacrylate and n-butyl methacrylate.

One kind of the alkyl methacrylate may be used alone, or two or more kinds thereof may be used in combination.

The monomer component (m11) may contain a monomer which is other than the alkyl acrylate, the polyfunctional monomer, and the alkyl methacrylate and has a double bond copolymerizable therewith (hereinafter, also referred to as “another monomer a”).

Examples of the other monomer a include other acrylic monomers (such as cyanoethyl acrylate, acrylamide, and (meth)acrylic acid), aromatic vinyl monomer (such as styrene and alkyl-substituted styrene), a vinyl cyanide monomer (such as acrylonitrile and methacrylonitrile).

One kind of the other monomer a may be used alone, or two or more kinds thereof may be used in combination.

The monomer component (m11) may contain a chain transfer agent.

Examples of the chain transfer agent include an alkyl mercaptan having 2 to 20 carbon atoms (such as n-octyl mercaptan), mercapto acid, thiophenol, and carbon tetrachloride.

One kind of the chain transfer agent may be used alone, or two or more kinds thereof may be used in combination.

A content of the alkyl acrylate in the monomer component (m11) is preferably 40% to 99.9% by mass with respect to a total mass of the monomer component (m11).

A content of the polyfunctional monomer in the monomer component (m11) is preferably 0.1% to 10% by mass with respect to a total mass of the monomer component (m11).

A content of the alkyl methacrylate in the monomer component (m11) is preferably 0% to 59.9% by mass with respect to a total mass of the monomer component (m11).

A content of the other monomer a in the monomer component (m11) is preferably 0% to 30% by mass with respect to a total mass of the monomer component (m11).

A Tg of the rubber polymer (A1a) is preferably lower than 25° C., more preferably 10° C. or lower, still more preferably 0° C. or lower, in that the rubber-containing polymer (A1) has excellent flexibility. The Tg of the rubber polymer (A1a) is preferably −100° C. or higher, more preferably −50° C. or higher. For example, the Tg of the rubber polymer (A1a) is preferably −100° C. or higher and lower than 25° C., more preferably −50° C. to 10° C., and still more preferably −50° C. to 0° C.

Examples of the alkyl methacrylate, which is the essential component of the monomer component (m12), include the same alkyl methacrylate mentioned in the description of the monomer component (m11).

One kind of the alkyl methacrylate may be used alone, or two or more kinds thereof may be used in combination.

The monomer component (m12) may contain an alkyl acrylate. Examples of the alkyl acrylate include the same alkyl acrylate mentioned in the description of the monomer component (m11).

One kind of the alkyl acrylate may be used alone, or two or more kinds thereof may be used in combination.

The monomer component (m12) may contain a monomer which is other than the alkyl methacrylate and the alkyl acrylate and has a double bond copolymerizable therewith (hereinafter, also referred to as “another monomer b”).

Examples of the other monomer b include the same monomer as the monomer a mentioned in the description of the monomer component (m11).

One kind of the other monomer b may be used alone, or two or more kinds thereof may be used in combination.

The monomer component (m12) may contain a chain transfer agent.

Examples of the chain transfer agent include the same chain transfer agent mentioned in the description of the monomer component (m11).

One kind of the chain transfer agent may be used alone, or two or more kinds thereof may be used in combination.

A content of the alkyl methacrylate in the monomer component (m12) is preferably 51% to 100% by mass with respect to a total mass of the monomer component (m12).

A content of the alkyl acrylate in the monomer component (m12) is preferably 0% to 20% by mass with respect to a total mass of the monomer component (m12).

The content of the other monomer b in the monomer component (m12) is preferably 0% to 49% by mass with respect to the total mass of the monomer component (m12).

Examples of the alkyl acrylate, which is the essential component of the monomer component (m13), include the same alkyl acrylate mentioned in the description of the monomer component (m11).

As the alkyl acrylate, one type may be used alone, or two or more types may be used in combination.

Examples of the alkyl methacrylate, which is the essential component of the monomer component (m13), include the same alkyl methacrylate mentioned in the description of the monomer component (m11).

One kind of the alkyl methacrylate may be used alone, or two or more kinds thereof may be used in combination.

Examples of the polyfunctional monomer, which is the essential component of the monomer component (m13), include the same polyfunctional monomer mentioned in the description of the monomer component (m11).

As the polyfunctional monomer, one type may be used alone, or two or more types may be used in combination.

The monomer component (m13) may contain a monomer which is other than the alkyl acrylate, the polyfunctional monomer, and the alkyl methacrylate and has a double bond copolymerizable therewith (hereinafter, also referred to as “another monomer c”).

Examples of the other monomer c include the same monomer as the monomer a mentioned in the description of the monomer component (m11).

One kind of the other monomer c may be used alone, or two or more kinds thereof may be used in combination.

The monomer component (m13) may contain a chain transfer agent.

Examples of the chain transfer agent include the same chain transfer agent mentioned in the description of the monomer component (m11).

One kind of the chain transfer agent may be used alone, or two or more kinds thereof may be used in combination.

A content of the alkyl acrylate in the monomer component (m13) is preferably 9.9% to 90% by mass with respect to a total mass of the monomer component (m13).

A content of the alkyl methacrylate in the monomer component (m13) is preferably 9.9% to 90% by mass with respect to a total mass of the monomer component (m13).

A content of the polyfunctional monomer in the monomer component (m13) is preferably 0.1% to 10% by mass with respect to a total mass of the monomer component (m13).

The content of the other monomer c in the monomer component (m13) is preferably 0% to 20% by mass with respect to the total mass of the monomer component (m13).

A composition of the monomer component (m13) is preferably different from a composition of the monomer component (m11).

By making the composition of the monomer component (m11) and the monomer component (m13) different from each other, it is easy to improve the molding whitening resistance of the acrylic resin film.

The “different composition” referred to regarding the polymer indicates that at least one of the kinds and contents of the monomer forming the polymer is different.

A Tg of the polymer obtained by polymerizing only the monomer component (m13) is preferably higher than the Tg of the rubber polymer (A1a) in that the acrylic resin film has excellent molding whitening resistance.

The Tg of the polymer obtained by polymerizing only the monomer component (m13) is preferably 10° C. or higher in that the heat resistance and flexibility are excellent. The Tg of the polymer obtained by polymerizing only the monomer component (m13) is preferably 100° C. or lower, more preferably 80° C. or lower, and still more preferably 70° C. or lower in that film forming property and molding whitening resistance are excellent. For example, the Tg of the polymer obtained by polymerizing only the monomer component (m13) is preferably 10° C. to 100° C., more preferably 10° C. to 80° C., and even more preferably 10° C. to 70° C.

(Method for Producing Rubber-Containing Polymer (A1))

Examples of a method for producing the rubber-containing polymer (A1) include a sequential multi-stage emulsion polymerization method and an emulsion suspension polymerization method.

Examples of the sequential multi-stage emulsion polymerization method include a method in which an emulsion prepared by mixing the monomer component (m11), water, and a surfactant is supplied to a reactor and polymerized to obtain the rubber polymer (A1a), and then, the monomer component (m13) is supplied to the reactor, as needed, and polymerized, and then the monomer component (m12) is supplied to the reactor, and polymerized.

Examples of the emulsion suspension polymerization method include a method in which in the presence of the rubber polymer (A1a), the monomer component (m13) is sequentially subjected to multi-stage emulsion polymerization as needed, and then the monomer component (m12) is converted to a suspension polymerization system, when polymerizing the monomer component (m12).

The acrylic resin film obtained by using the rubber-containing polymer (A1) obtained by these methods is preferable in that the number of fish eyes in the film is small.

Examples of the method for preparing the emulsion by mixing the monomer component (m11), the water, and the surfactant include a method in which the monomer component (m11) is charged in the water and then the surfactant is added thereto, a method in which the surfactant is charged in the water and then the monomer component (m11) is added thereto, and a method in which the surfactant is charged in the monomer component (m11), and then the water is added thereto.

Examples of a mixing device for preparing the emulsion by mixing the monomer component (m11), the water, and the surfactant include a stirrer equipped with a stirring blade, a forced emulsifying device (such as a homogenizer and a homomixer), and membrane emulsifying device.

For the emulsion, any of a W/O type dispersion in which water droplets are dispersed in an oil of the monomer component (m11) and an O/W type dispersion in which oil droplets of the monomer component (m11) are dispersed in the water can be used.

Examples of the surfactant used in the sequential multi-stage emulsion polymerization method include an anionic surfactant, a cationic surfactant, and a nonionic surfactant.

One kind of the surfactant may be used alone, or two or more kinds thereof may be used in combination.

Examples of the anionic surfactant include carboxylates (such as rosin soap, potassium oleate, sodium stearate, sodium myristate, sodium N-lauroyl sarcosinate, and dipotassium alkenyl succinate basis), sulfate ester salt (such as sodium lauryl sulfate), sulfonate salt (such as sodium dioctyl sulfosuccinate, sodium dodecylbenzene sulfonate, sodium alkyldiphenyl ether disulfonate basis), and phosphate ester salt (such as polyoxyethylene alkyl phenyl ether sodium phosphate and polyoxyethylene alkyl ether sodium phosphate basis).

Examples of a commercially available product of the anionic surfactant include ELEMINOL (registered trademark, the same applies below) NC-718 manufactured by Sanyo Chemical Industries, Ltd., Phosphanol (registered trademark, the same applies below) LS-529, RS-610NA, RS-620NA, RS-630NA, RS-640NA, RS-650NA, RS-660NA manufactured by Toho Chemical Industry Co., Ltd., and LATEMUL P-0404, P-0405, P-0406, P-0407 (both are trade names) manufactured by Kao Corporation.

Examples of a method for polymerizing the monomer component (m11) include a method of polymerizing the monomer component (m11) all at once and a method of polymerizing in multiple stages by dividing the monomer component (m11) into two or more. In a case of the monomer component (m11) to be polymerized in multiple stages, the monomer components having the same composition may be polymerized in multiple stages, or the monomer components having different compositions may be polymerized in multiple stages.

Examples of a polymerization initiator used when polymerizing the monomer component (m11), the monomer component (m12) and the monomer component (m13) include known polymerization initiators.

Examples of the polymerization initiator include peroxide, an azo initiator, a redox initiator obtained by combining the peroxide or the azo initiator and oxidizing agent/reducing agent.

Examples of the redox initiator include a sulfoxylate initiator obtained by combining ferrous sulfate, disodium ethylenediamine tetraacetate, rongalite, and hydroperoxide. Examples of the hydroperoxide include cumene hydroperoxide and t-butyl hydroperoxide.

Examples of a method of adding the polymerization initiator include a method of adding the polymerization initiator to one or both of an aqueous phase and a monomer phase.

In a case where latex of the rubber-containing polymer (A1) is produced by the sequential multi-stage emulsion polymerization method, it is preferable to use a method in which an aqueous solution in a polymerization vessel, that contains ferrous sulfate, disodium ethylenediamine tetraacetate, and rongalite was heated to the polymerization temperature, and then the emulsion prepared by mixing the monomer component (m11), the water, and the surfactant is supplied to a reactor and polymerized, and as needed, the monomer component (m13) is supplied to the reactor and polymerized, and then the monomer component (m12) is supplied to the reactor and polymerized.

The polymerization temperature varies depending on a kind and amount of the polymerization initiator to be used, but is, for example, 40° C. to 120° C.

The latex of the rubber-containing polymer (A1) may be treated by using a filtration device provided with a filter medium, as needed. The filtration device is used for removing scale from the latex of the rubber-containing polymer (A1), and for removing impurities of raw materials or mixed from the outside during polymerization. Examples of the filtration device include a GAF filter system of ISP Filters PTE Limited using a bag-shaped mesh filter, a centrifugal filtration device in which a cylindrical filter medium is provided on an inner surface of a cylindrical filtration chamber, and a stirring blade is provided in the filter medium, and a vibration type filtration device in which the filter medium moves in a horizontal circular motion and a vertical amplitude motion with respect to a surface of the filter medium.

The rubber-containing polymer (A1) can be obtained as a powder by recovering from the latex of the rubber-containing polymer (A1).

Examples of a method for recovering the rubber-containing polymer (A1) from the latex of the rubber-containing polymer (A1) include a solidification method by salting out or acid analysis, a spray drying method, and a freeze drying method.

In a case where the rubber-containing polymer (A1) is recovered by the solidification method by a salting-out treatment using a metal salt, a residual metal content in the finally obtained rubber-containing polymer (A1) is preferably to be 800 ppm or less, and the smaller the residual metal content, the more preferable.

In a case where a metal salt having a strong affinity with water, such as calcium, magnesium, and sodium is used as the metal salt in the salting-out treatment, the whitening phenomenon when the acrylic resin film is immersed in boiling water can be easily suppressed by reducing the residual metal content in the rubber-containing polymer (A1) as much as possible.

The amount of the monomer component (m11) used when producing the rubber-containing polymer (A1) is preferably 5% to 70% by mass, and more preferably 20% to 60% by mass, in the total 100% by mass of the monomer component (m11), the monomer component (m12), and the monomer component (m13), in that the film forming property, the molding whitening resistance, the heat resistance, and the flexibility are excellent.

The amount of the monomer component (m12) used when producing the rubber-containing polymer (A1) is preferably 20% to 95% by mass, and more preferably 30% to 80% by mass, in the total 100% by mass of the monomer component (m11), the monomer component (m12), and the monomer component (m13), in that the film forming property, the molding whitening resistance, the heat resistance, and the flexibility are excellent.

The amount of the monomer component (m13) used when producing the rubber-containing polymer (A1) is preferably 0% to 35% by mass, and more preferably 5% to 20% by mass, in the total 100% by mass of the monomer component (m11), the monomer component (m12), and the monomer component (m13), in that the film forming property, the molding whitening resistance, the heat resistance, and the flexibility are excellent.

(Thermoplastic Polymer (A2))

The thermoplastic polymer (A2) may be a polymer containing a structural unit derived from alkyl methacrylate as a main component.

The thermoplastic polymer (A2) is preferably a polymer obtained by polymerizing the monomer component (m2) that contains 50% to 100% by mass of the alkyl methacrylate, 0 to 50% by mass of alkyl acrylate, and 0% to 49% by mass of another monomer having a double bond copolymerizable therewith (hereinafter, also referred to as “another monomer d”), in that the acrylic resin film has excellent heat resistance.

Examples of the each monomer in the monomer component (m2) include the same monomer as respective monomers mentioned in the description of the monomer component (m11).

One kind of the each monomer may be used alone, or two or more kinds thereof may be used in combination.

A content of the alkyl methacrylate in the monomer component (m2) is preferably 60% to 100% by mass, more preferably 85% to 99.9% by mass, and still more preferably 92% to 99.9% by mass, with respect to the total mass of the monomer component (m2), in that the acrylic resin film has excellent heat resistance.

A content of the alkyl acrylate in the monomer component (m2) is preferably 0% to 40% by mass, more preferably 0.1% to 15% by mass, and still more preferably 0.1% to 8% by mass, with respect to the total mass of the monomer component (m2), in that the acrylic resin film has excellent heat resistance.

A content of the other monomer d in the monomer component (m2) is preferably 0% to 40% by mass, more preferably 0% to 14.9% by mass, and still more preferably 0 to 7.9 by mass, with respect to the total mass of the monomer component (m2), in that the acrylic resin film has excellent heat resistance.

The thermoplastic polymer (A2) preferably has a reduced viscosity of 0.1 L/g or lower when measured at 25° C. by dissolving 0.1 g of the polymer in 100 mL of chloroform.

Examples of a method for polymerizing the thermoplastic polymer (A2) include a suspension polymerization method, an emulsion polymerization method, and a massive polymerization method.

(Fluorescent Dye (B))

The fluorescent dye (B) is not particularly limited, and for example, a known fluorescent dye can be used.

The fluorescent dye (B) is preferably selected and used as appropriate in consideration of a chromaticity coordinate (x, y) required as the retroreflective sheet when the acrylic resin film is used as the skin material of the retroreflective sheet.

The following range of the chromaticity coordinates (x, y) required as the retroreflective sheet is disclosed in ASTM D4956, for example. The retroreflective sheet preferably satisfies the range of a certain chromaticity coordinate (x, y), as needed. A color of the retroreflective sheet having a yellow-green color (Fluorescent Yellow-Green) is within a range surrounded by four points of (0.387, 0.610), (0.369, 0.546), (0.428, 0.496), and (0.460, 0.540) (hereinafter, also referred to as a “range Yg”).

A color of the retroreflective sheet having a yellow color (Fluorescent Yellow) is within a range surrounded by four points of (0.479, 0.520), (0.446, 0.483), (0.512, 0.421), and (0.557, 0.442) (hereinafter, also referred to as a “range Ye”).

A color of the retroreflective sheet having an orange color (Fluorescent Orange) is within a range surrounded by four points of (0.583, 0.416), (0.535, 0.400), (0.595, 0.351), and (0.645, 0.355) (hereinafter, also referred to as a “range Or”).

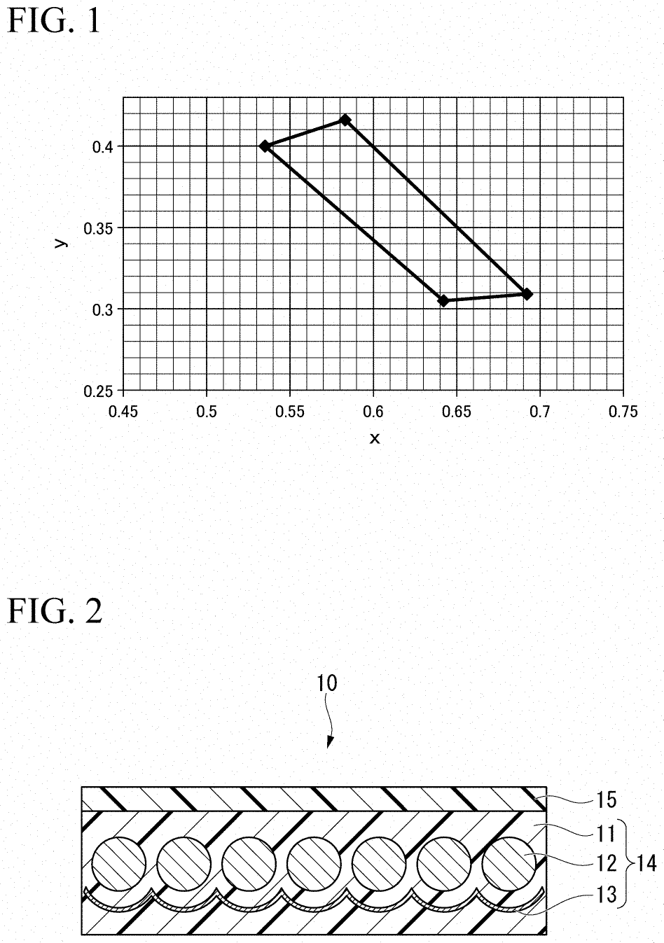

Here, when using the range A1 described above as an example, the “range surrounded by four points” means an area surrounded by (0.583, 0.416), (0.535, 0.400), (0.642, 0.305), and (0.692, 0.309) in the chromaticity coordinate (x, y), by connecting each coordinate from the first (0.583, 0.416) in order with a straight line, as shown in FIG. 1.

The fluorescent dye (B) preferably includes at least one selected from the group consisting of a thioxanthene dye, a thioindigoid dye, an anthraquinone dye, a benzoxazole coumarin dye, a perylene dye, a peryleneimide dye, a benzopyran dye, an anthracene dye, and an isoquinoline dye, in terms of excellent transparency and hue.

The fluorescent dye (B) preferably contains one or both of a yellow fluorescent dye and a red fluorescent dye, from the viewpoint of chromaticity coordinate (x, y). Also, in another aspect, the fluorescent dye (B) preferably contains one or both of a yellow fluorescent dye and a red fluorescent dye and does not contain other fluorescent dyes, from the viewpoint of chromaticity coordinate (x, y).

Here, the thioxanthene dye means a dye containing a compound having a thioxanthene skeleton in a molecule.

The thioindigoid dye means a dye containing a compound having a thioindigo skeleton in a molecule.

The anthraquinone dye means a dye containing a compound having an anthraquinone skeleton in a molecule.

The benzoxazole coumarin dye means a dye containing a compound having a 3-(benzoxazole-2-yl) coumarin skeleton in a molecule.

The perylene dye means a dye containing a compound having a perylene skeleton in a molecule (however, excluding those corresponding to the following peryleneimide dye).

The peryleneimide dye means a dye containing a compound having a perylenetetracarboxydiimide skeleton in a molecule.

The benzopyran dye means a dye containing a compound having a benzopyran skeleton in a molecule (however, excluding those corresponding to the benzoxazole coumarin dye).

The anthracene dye means a dye containing a compound having an anthracene skeleton in a molecule.

The isoquinoline dye means a dye containing a compound having an isoquinoline skeleton in a molecule.

The yellow fluorescent dye means a dye whose color shade is yellow in a color index name.

The red fluorescent dye means a dye whose color shade is red in the color index name.

Examples of a commercially available product of the fluorescent dye include the followings.

Thioxanthene dye: C.I. Solvent Yellow 98 (“DYMIC MBR D-70” manufactured by Dainichiseika Kogyo Co., Ltd.)

Anthraquinone dye: C.I. Solvent Orange 63 (“DYMIC MBR D-74” manufactured by Dainichiseika Kogyo Co., Ltd.)

Perylene dye: C.I. Solvent Orange 55 (“DYMIC MBR 120830 Orange” manufactured by Dainichiseika Kogyo Co., Ltd.) and “Lumogen (registered trademark, the same applies below) F Yellow 083” and “Lumogen F Yellow 170” manufactured by BASF

Peryleneimide dye: “Lumogen F Orange 240” and “Lumogen F Red 305” manufactured by BASF Benzopyran dye: C.I. Solvent Red 197 (“DYMIC MBR D-75” manufactured by

Dainichiseika Kogyo Co., Ltd.)

Anthracene dye: C.I. Solvent Red 196 (“DYMIC MBR D-77” manufactured by Dainichiseika Kogyo Co., Ltd.)

Isoquinoline dye: C.I. Solvent Yellow 104 (“DYMIC MBR D-71” manufactured by Dainichiseika Kogyo Co., Ltd.)

One kind of the fluorescent dye (B) may be used alone, or two or more kinds thereof may be used in combination.

(Colorant (C))

The colorant (C) is at least one kind selected from the group consisting of pigments and dyes (here, a fluorescent dye is excluded).

The colorant (C) is not particularly limited, and for example, a known colorant can be used.

The colorant (C) is preferably selected and used as appropriate in consideration of a chromaticity coordinate (x, y) required as the retroreflective sheet when the acrylic resin film is used as the retroreflective sheet. In the present invention, it is more preferable that the colorant (C) is added to the acrylic resin composition so as to have the chromaticity coordinate similar to the chromaticity coordinate (x, y) when molded into the acrylic resin film using the fluorescent dye (B).

The kind of the colorant (C) is not particularly limited, and any kind in the group consisting of the pigments and the dyes can be selected and used.

One kind of the colorant (C) may be used alone, or two or more kinds thereof may be used in combination.

In a case where the fluorescent dye (B) contains one or both of the yellow fluorescent dye and the red fluorescent dye, or in a case where the fluorescent dye (B) contains one or both of the yellow fluorescent dye and the red fluorescent dye and does not contain other fluorescent dyes, the colorant (C) is preferably selected from, for example, a white colorant, a yellow colorant, a red colorant, and an orange colorant, and more preferably selected from the yellow colorant, the red colorant, and the orange colorant.

Here, the white colorant means a colorant whose color shade is white in the color index name, which does not correspond to the fluorescent dye.

The yellow colorant means a colorant whose color shade is yellow in the color index name, which does not correspond to the fluorescent dye.

The red colorant means a colorant whose color shade is red in the color index name, which does not correspond to the fluorescent dye.

The orange colorant means a colorant whose color shade is orange in the color index name, which does not correspond to the fluorescent dye.

Examples of the white colorant include titanium oxide, barium sulfate, and zinc oxide.

Examples of a commercially available product of the titanium oxide include “DYMIC MBR 002 White” manufactured by Dainichiseika Kogyo Co., Ltd.

Examples of the yellow colorant include a condensed azo colorant, an isoindolinone colorant, and an anthraquinone colorant.

The condensed azo colorant means a colorant containing a compound obtained by condensing an acid chloride derivative of an azo dye having an azo bond in a molecule with monoamines or diamines.

The isoindolinone colorant means a colorant containing a compound having an isoindolinone skeleton in a molecule.

The anthraquinone colorant means a colorant containing a compound having an anthraquinone skeleton in a molecule.

Specific examples of these colorants include the followings.

Condensed azo colorant: C.I. Pigment Yellow 93, C.I. Pigment Yellow 95, C.I. Pigment Yellow 128, and the like

Isoindolinone colorant: C.I. Pigment Yellow 109, C.I. Pigment Yellow 110, C.I. Pigment Yellow 139, and the like

Anthraquinone colorant: C.I. Pigment Yellow 24, C.I. Pigment Yellow 99, C.I. Pigment Yellow 108, C.I. Pigment Yellow 123, C.I. Pigment Yellow 147, C.I. Pigment Yellow 199, C.I. Solvent Yellow 163, and the like

Examples of a commercially available product of the C. I. Pigment Yellow 110 include “DYMIC MBR 443 Yellow” manufactured by Dainichiseika Kogyo Co., Ltd. and “Cromophtal (registered trademark, the same applies below) Yellow 2RLP”, “Cromophtal Yellow 2RLTS”, and “Cromophtal Yellow3RT” which are manufactured by BASF″, “Irgazin (registered trademark, the same applies below) Yellow 2RLT”, “Irgazin Yellow 3RLTN”, “Microlith (registered trademark, the same applies below) Yellow 3R-K/KP”, “Microlith Yellow 3R-T”, “Microlith Yellow 3R-WA”, “Microlen Yellow 2RLTS-MC”, and “Microlen Yellow 2RLTS-UA”, and “Unisperse (registered trademark, the same applies below) Yellow 2RLT-S”.

Examples of a commercially available product of the C. I. Solvent Yellow 163 include, for example, “DYMIC MBR D-05 Yellow” manufactured by Dainichiseika Kogyo Co., Ltd. and “Oracet (registered trademark, the same applies below) Yellow GHS manufactured by BASF.

Examples of the red colorant include a condensed azo colorant, a diazo colorant, an anthraquinone colorant, a peryleneimide colorant, a perinone colorant, a quinacridone colorant, and a diketopyrrolopyrrole colorant.

The diazo colorant means a colorant containing a compound having two azo bonds in a molecule.

The peryleneimide colorant means a colorant containing a compound having a perylenetetracarboxydiimide skeleton in a molecule.

The perinone colorant means a colorant containing a compound having a perinone skeleton in a molecule.

The quinacridone colorant means a colorant containing a compound having a quinacridone skeleton in a molecule.

The diketopyrrolopyrrole colorant means a colorant containing a compound having a diketopyrrolopyrrole skeleton in a molecule.

Specifically, the followings can be mentioned.

Condensed azo colorant: C. I. Pigment Red 4, C. I. Pigment Red 166, C. I. Pigment Red 214, C. I. Pigment Red 221, and the like

Diazo colorant: C. I. Pigment Red 1, C. I. Pigment Red 2, C. I. Pigment Red 3, C. I. Pigment Red 4, C. I. Pigment Red 5, C. I. Pigment Red 6, C. I. Pigment Red7, C. I. Pigment Red 8, C. I. Pigment Red 9, C. I. Pigment Red 10, C. I. Pigment Red 11, C. I. Pigment Red 12, C. I. Pigment Red 14, C. I. Pigment Red 15, C. I. Pigment Red 16, C. I. Pigment Red 17, C. I. Pigment Red 18, C. I. Pigment Red 19, C. I. Pigment Red 21, C. I. Pigment Red 22, C. I. Pigment Red 30, C. I. Pigment Red 31, C. I. Pigment Red 32, C. I. Pigment Red 37, C. I. Pigment Red 38, C. I. Pigment Red 40, C. I. Pigment Red 41, C. I. Pigment Red 42, C. I. Pigment Red 49:2, C. I. Pigment Red 50:1, C. I. Pigment Red 52:1, C. I. Pigment Red 53:1, C. I. Pigment Red 57, C. I. Pigment Red 57:1, C. I. Pigment Red 58:2, C. I. Pigment Red 58:4, C. I. Pigment Red 60:1, C. I. Pigment Red 63:1, C. I. Pigment Red 63:2, C. I. Pigment Red 64:1, C. I. Pigment Red 114, C. I. Pigment Red 144, C. I. Pigment Red 146, C. I. Pigment Red 150, C. I. Pigment Red 151, C. I. Pigment Red 166, C. I. Pigment Red 170, C. I. Pigment Red 171, C. I. Pigment Red 175, C. I. Pigment Red 176, C. I. Pigment Red 178, C. I. Pigment Red 185, C. I. Pigment Red 187, C. I. Pigment Red 193, C. I. Pigment Red 214, C. I. Pigment Red 220, C. I. Pigment Red 221, C. I. Pigment Red 243, C. I. Pigment Red 245, C. I. Solvent Red 24, and the like

Anthraquinone colorant: C. I. Pigment Red 177, C. I. Pigment Red 216, C. I. Disperse Red 22, C. I. Disperse Red 57, C. I. Disperse Red 60, C. I. Solvent Red 4, C. I. Solvent Red 9, C. I. Solvent Red 11, C. I. Solvent Red 15, C. I. Solvent Red 52, C. I. Solvent Red 111, C. I. Solvent Red168, C. I. Solvent Red 207, and the like

Peryleneimide colorant: C. I. Pigment Red 149, and the like

Perinone colorant: C. I. Solvent Red 135, C. I. Solvent Red179, and the like

Quinacridone colorant: C. I. Disperse Red 122, C. I. Disperse Red 202, and the like

Diketopyrrolopyrrole colorant: C. I. Disperse Red 254, C. I. Disperse Red 255, C. I. Disperse Red 264, C. I. Disperse Red 272, and the like

Examples of a commercially available product of the C. I. Pigment Red 149 include “DYMIC MBR 155 Red” manufactured by Dainichiseika Kogyo Co., Ltd.

Examples of the orange colorant include an isoindolinone colorant, and diketopyrrolopyrrole colorant.

Specifically, the followings can be mentioned.

Isoindolinone colorant: C.I. Pigment Orange 61 and the like

Diketopyrrolopyrrole colorant: C.I. Disperse Orange 71, C.I. Disperse Orange 73, and the like

In addition, for the purpose of complementary colors, a colorant having other colors, such as a quinacridone colorant, an isoindoline colorant, a perylene colorant, a perinone colorant, a thioindigo colorant, and a quinophthalone colorant may be added.

(Light Stabilizer (D))

As the light stabilizer (D), a known compound can be used, and although not particularly limited, a hindered amine radical scavenger is preferably used.

The hindered amine radical scavenger is a compound having a piperidine ring having a plurality of substituents exhibiting steric hindrance action on two carbon atoms adjacent to a nitrogen atom. Examples of the substituent exhibiting the steric hindrance action include a methyl group.

Examples of the hindered amine radical scavenger include a compound having a 2,2,6,6-tetramethyl-4-piperidyl group and a compound having a 1,2,2,6,6-pentamethyl-4-piperidyl group.

Examples of a commercially available product of the hindered amine radical scavenger or a composition containing the hindered amine radical scavenger include Chimassorb (registered trademark, the same applies below) 119FL, 2020FDL, 944FD, and 944LD which are manufactured by BASF, Tinuvin (registered trademark, the same applies below) 622LD, 123S, 144, 765, 770, 770DF, 770FL, 111FD, 123, and 292, Sanol (registered trademark, the same applies below) LS-770, LS-765, LS-292, LS-2626, LS-744, and LS-440 which are manufactured by Sankyo Co., Ltd., and ADEKA STAB (registered trademark, the same applies below) LA-52, LA-57, LA-62, LA-63P, LA-68, LA-81, LA-82, and LA-87 (all are trade names) which are manufactured by ADEKA.

One kind of the light stabilizer (D) may be used alone, or two or more kinds thereof may be used in combination.

(Other Components)

A resin other than the acrylic resin (A) (hereinafter, also referred to as “other resin”) may be mixed in the acrylic resin composition, as needed, within the range not impairing the weather resistance.

Examples of the other resin include polycarbonate, polyethylene terephthalate, polyamide, polyethylene, polypropylene, polystyrene, polyvinyl chloride, an ethylene-vinyl alcohol copolymer, polyvinyl butyral, polyvinyl acetal, styrene thermoplastic elastomer, olefin thermoplastic elastomer, and acrylic thermoplastic elastomer.

For example, in a case where the acrylic resin (A) and polycarbonate are used in combination, a mass ratio of the acrylic resin (A) to the polycarbonate (Mass of acrylic resin (A)/Mass of polycarbonate) is preferably 95/5 to 80/20. When the mass ratio of the acrylic resin (A) to the polycarbonate is within the above range, a change in hue when the acrylic resin film is exposed tends to be small, and the weather resistance tends to be favorable.

The acrylic resin compositions may further include, as needed, various compounding agents such as a stabilizer, a lubricant, a processing aid, a matting agent, a light diffusing agent, a plasticizers, an impact resistant aid, a foaming agent, a filler, a colorant, an antibacterial agent, a fungicide, a release agent, an antistatic agent, an ultraviolet absorber, and an antioxidant.

The acrylic resin composition preferably contains the ultraviolet absorber from the viewpoint of imparting the weather resistance to the acrylic resin film used as a protective film for protecting a product.

A molecular weight of the ultraviolet absorber is preferably 300 or more, and more preferably 400 or more.

When the molecular weight of the ultraviolet absorber is equal to or more than the above lower limit value of the above range, it is easy to suppress stains on a die used when molding the acrylic resin composition.

Examples of a kind of the ultraviolet absorber include a benzotriazole ultraviolet absorber and a triazine ultraviolet absorber.

Examples of a commercially available product of the benzotriazole ultraviolet absorber include Tinuvin 234 manufactured by BASF and ADEKA STAB LA-31 manufactured by ADEKA (all are trade names).

Examples of a commercially available product of the triazine ultraviolet absorber include Tinuvin 1577 and 1600 manufactured by BASF and ADEKA STAB LA-F70 manufactured by ADEKA (all are trade names).

One kind of the ultraviolet absorber may be used alone, or two or more kinds thereof may be used in combination.

The acrylic resin composition preferably contains the antioxidant from the viewpoint of suppressing thermal coloring when molded into pellets and films.

As the antioxidant, a known compound can be used, and although not particularly limited, a phenolic antioxidant is preferably used.

Examples of the phenolic antioxidant include a hindered phenolic compound in which a bulky group is present at an ortho position of a hydroxyl group of a phenolic compound and conceals properties of a phenolic hydroxyl group.

Examples of a commercially available product of the antioxidant or a composition containing the antioxidant include Irganox (registered trademark, the same applies below) 1010, 1076, 1098, 245, and 3114 manufactured by BASF, and ADEKA STAB AO-20, AO-50, AO-60, AO-80, and AO-330 (all are trade names) manufactured by ADEKA.

One kind of the antioxidant may be used alone, or two or more kinds thereof may be used in combination.

(Ratio of Each Component)

In a case where the acrylic resin (A) contains the rubber-containing polymer (A1) and the thermoplastic polymer (A2), a mass ratio expressed by Mass of rubber-containing polymer (A1) Mass of thermoplastic polymer (A2) is preferably 90/10 to 20/80, more preferably 80/20 to 50/50, and still more preferably 80/20 to 60/40, in that it is easy to obtain the balance between the weather resistance and the mechanical strength.

A content of the fluorescent dye (B) contained in the acrylic resin composition is preferably 0.1 to 5.0 parts by mass, more preferably 0.15 to 4.0 parts by mass, and still more preferably 0.2 to 2.0 parts by mass, with respect to 100 parts by mass of the acrylic resin (A).

When the content of the fluorescent dye (B) is equal to or more than the above lower limit value, excellent color developing property is obtained, and the visibility when used as the skin material of the retroreflective sheet such as a road sign becomes favorable. When the content of the fluorescent dye (B) is equal to or less than the above upper limit value, fading can be suppressed and the weather resistance becomes favorable.

A content of the colorant (C) contained in the acrylic resin composition is 1.0 to 4.0 parts by mass, preferably 1.1 to 2.5 parts by mass, and still more preferably 1.2 to 2.2 parts by mass, with respect to 100 parts by mass of the acrylic resin (A).

When the content of the colorant (C) is equal to or more than the above lower limit value, the change in hue when the acrylic resin film is exposed is small and the weather resistance becomes favorable. When the content of the colorant (C) is equal to or less than the above upper limit value, it is possible to have a bright fluorescent color.

In a case where the acrylic resin composition contains a white pigment as the colorant (C), a content of the white pigment contained in the acrylic resin composition is preferably 0.03 to 3.0 parts by mass, preferably 0.1 to 2.0 parts by mass, and still more preferably 0.5 to 1.5 parts by mass, with respect to 100 parts by mass of the acrylic resin (A). In a case where the white pigment is less than 1 part by mass, the content of the colorant (C) is adjusted to be 1 part by mass or more in combination with another colorant.

When the content of the white pigment is equal to or more than the above lower limit value, brightness of the retroreflective sheet can be improved more effectively. When the content of the white pigment is equal to or less than the upper limit value, the haze of the acrylic resin film can be suppressed more effectively. As a result, the visibility of the obtained retroreflective sheet can be kept favorable.

A total of the content of the fluorescent dye (B) contained in the acrylic resin composition and the content of the colorant (C) contained in the acrylic resin composition is preferably 1.5 to 10.0 parts by mass, more preferably 1.5 to 7.0 parts by mass, and still more preferably 1.5 to 5.0 parts by mass, with respect to 100 parts by mass of the acrylic resin (A).

When the total of the content of the fluorescent dye (B) and the content of the colorant (C) is equal to or more than the above lower limit value, the acrylic resin film can be easily colored to a desired chromaticity coordinate (x, y). When the total of the content of the fluorescent dye (B) and the content of the colorant (C) is equal to or less than the upper limit value, transparency of the acrylic resin film can be maintained more effectively.

It is preferable that all of the content of the fluorescent dye (B) contained in the acrylic resin composition and the content of the colorant (C) contained in the acrylic resin composition are contained in a single layer. When all of the fluorescent dye (B) and the colorant (C) are present in a single layer, even in a case where a color of the fluorescent dye (B) faded after being used outdoors for a long time, probability that the colorant (C) is present in the vicinity of the fluorescent dye (B) that has faded increases and these colorants three-dimensionally reflect the color emitted by the fluorescent dye (B). Accordingly, a color tint of the fluorescent dye (B) can be maintained. Therefore, when all of the fluorescent dye (B) and colorant (C) are present in a single layer, the acrylic resin film can have a fluorescent color and the visibility, the weather resistance, and the transparency can be maintained more effectively.

In a case where the acrylic resin composition contains the light stabilizer (D), a content of the light stabilizer (D) contained in the acrylic resin composition is preferably 0.1 to 3.0 parts by mass, more preferably 0.15 to 1.5 parts by mass, and still more preferably 0.2 to 1.0 part by mass, with respect to 100 parts by mass of the acrylic resin (A).

When the content of the light stabilizer (D) is equal to or more than the above lower limit value, the weather resistance of the acrylic resin film can be further improved. When the content of the light stabilizer (D) is equal to or less than the above upper limit value, manufacturing costs can be suppressed while maintaining sufficient weather resistance.

In a case where the acrylic resin composition contains the ultraviolet absorber, a content of the ultraviolet absorber contained in the acrylic resin composition is preferably 0.1 to 5.0 parts by mass, more preferably 0.2 to 4.0 parts by mass, and still more preferably 0.3 to 3.0 parts by mass, with respect to 100 parts by mass of the acrylic resin (A).

When the content of the ultraviolet absorber is equal to or more than the above lower limit value, the weather resistance of the acrylic resin film can be further improved. When the content of the ultraviolet absorber is equal to or less than the above upper limit value, manufacturing costs can be suppressed while maintaining sufficient weather resistance.

In a case where the acrylic resin composition contains the antioxidant, a content of the antioxidant contained in the acrylic resin composition is preferably 0.01 to 2.0 parts by mass, more preferably 0.02 to 1.5 parts by mass, and still more preferably 0.03 to 1.0 part by mass, with respect to 100 parts by mass of the acrylic resin (A). When the content of the antioxidant is equal to or more than the above lower limit value, it is possible to suppress the thermal coloring when molding the acrylic resin composition into pellets or films. When the content of the antioxidant is equal to or less than the above upper limit value, manufacturing costs can be suppressed while maintaining sufficient heat discoloration resistance.

Examples of a shape of the acrylic resin composition include a lump, a powder, and a pellet, and the pellet is preferable in that the acrylic resin composition has excellent handleability.

Examples of a method of adding the fluorescent dye (B), the colorant (C), the light stabilizer (D), and other components to the acrylic resin (A) include a method of adding the components before forming the acrylic resin composition into the pellet, and a method of adding the components to the pelletized acrylic resin (A), and the method of adding the components before forming the acrylic resin composition into the pellet is preferable in that the acrylic resin composition has handleability and uneven coloring of a film when molding into a film.

(Mechanism of Action)

The acrylic resin composition described above contains the fluorescent dye (B), and thus has a fluorescent color. Therefore, the visibility of the film is favorable.

Also, since the acrylic resin (A) is contained, the weather resistance is better than that of a film of the related art, containing polycarbonate.

In addition, since the colorant (C) is contained, the color tint is maintained by the colorant (C) even if the color due to the fluorescent dye (B) faded when used outdoors for a long time. Therefore, the weather resistance is favorable.

Also, when using the acrylic resin composition having favorable weather resistance, a film whose color does not easily fade even when used outdoors for a long time is obtained.

### <Acrylic Resin Film for Retroreflective Sheet>

The acrylic resin film for a retroreflective sheet (hereinafter, also simply referred to as an “acrylic resin film”), which is one aspect of the present invention, includes the acrylic resin composition described above. Specifically, the acrylic resin film is obtained by molding the acrylic resin composition described above.

The acrylic resin film for a retroreflective sheet of the present invention is preferably a single layer film formed from the acrylic resin composition.

When using the acrylic resin composition described above, it is possible to provide an acrylic resin film having the favorable weather resistance and fluorescent color, in which there is little change in appearance even in a case of being exposed to a weather resistance test or outdoors when used as the skin material for the retroreflective sheet. In addition, it is easy to provide an acrylic resin film having a fluorescent color, that satisfies the chromaticity coordinate (x, y) required when used as the skin material of the retroreflective sheet.

The chromaticity coordinate (x, y) of the acrylic resin film in the XYZ color system is preferably within the range A1, more preferably within a range of (0.583, 0.416), (0.535, 0.400), (0.614, 0.330), and (0.662, 0.338) (hereinafter, also referred to as a “range A2”), and still more preferably within a range of (0.609, 0.390), (0.558, 0.380), (0.614, 0.330), and (0.662, 0.338) (hereinafter, also referred to as a “range A3”).

When the chromaticity coordinate (x, y) of the acrylic resin film in the XYZ color system is within the above range, in a case where the acrylic resin film is used as the skin material of the retroreflective sheet, the retroreflective sheet has a fluorescent orange color. For example, it is possible to satisfy a desired chromaticity coordinate (x, y) as a construction sign, and tends to improve the visibility of the retroreflective sheet.

AY value of the acrylic resin film in the XYZ color system is preferably 10 to 40, and more preferably 15 to 40.

When the Y value is equal to or more than the above lower limit value, a reflection performance of the retroreflective sheet using the acrylic resin film as the skin material becomes favorable. When the Y value is equal to or less than the above upper limit value, the visibility of the retroreflective sheet using the acrylic resin film as the skin material becomes excellent.

The haze of the acrylic resin film is preferably 5% to 40%, and more preferably 8% to 30%.

When the haze is within the above range, the appearance of the retroreflective sheet using the acrylic resin film as the skin material becomes favorable, and the retroreflective sheet having excellent visibility can be obtained.

A thickness of the acrylic resin film is preferably 10 to 500 μm, and more preferably 30 to 200 μm, in terms of excellent handleability.

When the acrylic resin film is stacked on a prism type retroreflective sheet (white) (Nikkalite (registered trademark, the same applies below) CRG manufactured by Nippon Carbide Industries Co., Inc.) and a lightness (L* value) of the acrylic resin film is measured from the acrylic resin film side under conditions of 0° illumination for a reflection measurement, 45° circumferential light reception, standard light D65, and 10° field of view, the lightness (L* value) is preferably 35 to 51, and more preferably 36 to 48.

When the L* value is within the above range, vividness becomes favorable and a retroreflective sheet having excellent visibility can be obtained.

The acrylic resin film can be produced by molding the acrylic resin composition by a known molding method.

Examples of the molding method include a melt extrusion method (such as a melt casting method, a T-die method, and an inflation method) and a calendar method, and the T-die method is preferable in that it is excellent in economy.

The acrylic resin film formed by an extruder or the like can be wound into a tubular object such as a paper tube by a winder to form a roll-shaped article.

A fine structure may be formed on the surface of the acrylic resin film. Examples of a method for forming the fine structure include a thermal transfer method and an etching method, and the thermal transfer method is preferable in that it is excellent in productivity and economy.

The thermal transfer method is a method in which a die having a fine structure is heated and the heated die is pressed onto the surface of an acrylic resin film to transfer the fine structure. Examples of the thermal transfer method include a method in which a die having a fine structure is hot-pressed on an acrylic resin film cut out from a roll-shaped article to thermally transfer the fine structure in a single sheet, and a continuous shaping method in which a die having a heated belt-shaped fine structure is pressed by sandwiching an acrylic resin film unwound from a roll-shaped article using a nip roll to thermally transfer the fine structure to the surface of the acrylic resin film.

Examples of the method for producing the die having the fine structure include a sandblasting method, an etching method, and an electric discharge machining method.

### <Retroreflective Sheet>

The retroreflective sheet according to one aspect of the present invention (hereinafter, also simply referred to as a “retroreflective sheet”) has the acrylic resin film for a retroreflective sheet according to one aspect of the present invention.

The chromaticity coordinate (x, y) of the retroreflective sheet in an XYZ color system is within the range A1. The chromaticity coordinate (x, y) of the retroreflective sheet in the XYZ color system is preferably within the range A2, and more preferably within the range A3.

When the chromaticity coordinate (x, y) of the retroreflective sheet in the XYZ color system is within the above range, the retroreflective sheet has a fluorescent orange color. For example, it is possible to satisfy a desired chromaticity coordinate (x, y) as a construction sign, and tends to improve the visibility of the retroreflective sheet.

The retroreflective sheet has the acrylic resin film for a retroreflective sheet of the present invention as a skin material, in that it is easy to protect the retroreflective sheet and impart designability to the retroreflective sheet. The acrylic resin film may be one layer or may have a multi-layer structure having two or more layers.

The retroreflective sheet preferably has a retroreflective element layer from the viewpoint of excellent retroreflective property. The skin material may also serve as a retroreflective element layer.

The retroreflective element layer preferably includes a spherical lens or a prism from the viewpoint of excellent retroreflective property.

The retroreflective element layer may have a binder layer for holding the spherical lens or adhering to the skin material. Examples of the binder layer include a thermoplastic resins.

A support layer may be provided on the surface of the retroreflective element layer opposite to the skin material in order to improve the strength of the retroreflective sheet, improve the dimensional stability, and prevent the penetration of moisture or chemicals. Examples of materials forming the support layer include a resin, a fiber, cloths, and a thin metal sheet (such as stainless steel and aluminum). One kind of the material forming the support layer may be used alone, or two or more kinds thereof may be used in combination.

An adhesive layer may be provided on a surface of the retroreflective element layer opposite to the skin material or a surface of the support layer opposite to the retroreflective element layer, in order to attaching the retroreflective sheet to a metal plate, a wooden plate, a glass plate, a plastic plate, and the like. In addition, a release material layer for protecting the adhesive layer may be provided. As the adhesive and the release material, known materials are appropriately selected and used.

Examples of a kind of the retroreflective sheet include an enclosed lens type retroreflective sheet, a capsule type retroreflective sheet, and a prism type retroreflective sheet. The acrylic resin film can be used as a skin material for any kind of the retroreflective sheets. Furthermore, the acrylic resin film can be used as a skin material that also serves as a retroreflective element layer of the prism type retroreflective sheet by forming a prism on a surface. In this case, a side on which the prism is not formed is the surface side, and a side on which the prism is formed is the retroreflective element.

FIG. 2 is a schematic sectional view showing an example of the enclosed lens type retroreflective sheet. An enclosed lens type retroreflective sheet 10 includes: a retroreflective element layer 14 in which a plurality of spherical lenses 12 are enclosed in a binder layer 11, in a state of being aligned at equal intervals, and hemispherical reflective films 13 corresponding to the spherical lens 12 are continuously provided below the spherical lens 12; and a skin material 15 laminated on the retroreflective element layer 14.

FIG. 3 is a schematic sectional view showing an example of the capsule type retroreflective sheet. A capsule type retroreflective sheet 20 includes: a retroreflective element layer 24 in which a plurality of spherical lenses 22 are half-embedded on a binder layer 21, in a state of being aligned at equal intervals, and a reflective films 23 are formed on surfaces of embedded parts of the spherical lenses 22; and a skin material 25 laminated on the retroreflective element layer 24, in which independent subdivision spaces 27 separated by a convex connecting wall 26 are formed between the retroreflective element layer 24 and the skin material 25.

FIG. 4 is a schematic sectional view showing an example of the prism type retroreflective sheet. The prism type retroreflective sheet 30 includes a support layer 32 having a plurality of convex connecting walls 31 on a surface, and a retroreflective element layer 34 including a skin material having a plurality of prisms 33 formed on the support layer 32 side, in which independent subdivision spaces 35 separated by a connecting wall 31 are formed between the support layer 32 and the retroreflective element layer 34 (skin material).

The capsule type retroreflective sheet 20 is manufactured, for example, as follows.

First, an upper hemisphere of the spherical lens 22 (glass beads) is once embedded in a temporary support layer. A metal is vapor-deposited on the lower hemisphere of the spherical lens 22 and in a gap between the spherical lenses 22 to form the reflective film 23. A thermoplastic resin is applied to the surface of the reflective film 23 to form the binder layer 21. As needed, the surface of the binder layer 21 is covered with a heat-resistant resin film or the like to provide a support layer (not shown). The temporary support layer is peeled off, and the skin material 25 including an acrylic resin film is stacked on the exposed upper hemisphere of the spherical lens 22. In order to form the desired independent subdivision space 27, a die having a convex mesh pattern is stacked on the binder layer 21 (or support layer) side and hot pressed, and the binder layer 21 is heat-melted in a mesh pattern and partially welded to the skin material 25. The independent subdivision spaces 27 separated by a mesh-patterned connecting wall 26 are formed to obtain the capsule type retroreflective sheet 20.

A prism type retroreflective sheet 30 is manufactured, for example, as follows.

A prism 33 is formed on one side of the acrylic resin film by hot pressing to obtain a skin material that also serves as a retroreflective element layer 34. The retroreflective element layer 34 and the support layer 32 including a thermoplastic resin sheet are stacked so that the prism 33 is on the support layer 32 side. The support layer 32 side is passed between the die roll having the convex mesh pattern and the rubber roll so as to be in contact with a die roll, and hot pressed to heat-melt the support layer 32 into a mesh pattern, and partially welded to the retroreflective element layer 34. The independent subdivision spaces 35 separated by a mesh-patterned connecting wall 31 are formed to obtain the prism type retroreflective sheet 30.

### EXAMPLES

Hereinafter, the present invention will be described in more detail based on examples, but the present invention is not limited to the following examples as long as the gist of the present invention is not exceeded.

Further, in the following examples, “parts” represents “parts by mass” and “%” represents “% by mass”.

(Mass Average Particle Size of Rubber-Containing Polymer (A1))

The mass average particle size of the latex of the rubber-containing polymer (A1) obtained by the emulsion polymerization method was determined by the dynamic light scattering method using a light scattering photometer (DLS-700, manufactured by Otsuka Electronics Co., Ltd.).

(Gel Content of Acrylic Resin (A))

A “gel content” is calculated by a formula below, by extracting a predetermined amount (mass before extraction) of an acrylic resin (A) in an acetone solvent under reflux, separating the treated liquid by centrifugation, drying an acetone-insoluble matter, and then measuring the mass (mass after extraction).

Gel content (%)=Mass after extraction (g)/Mass before extraction (g)×100

(Total Light Transmittance of Acrylic Resin Film)

A total light transmittance of the acrylic resin film was measured in accordance with JIS K 7361-1: 1997.

(Haze or Acrylic Resin Film)

The haze of the acrylic resin film was measured in accordance with JIS K 7136: 2000.

(Chromaticity Coordinate (x, y) and Y Value of Acrylic Resin Film)

The acrylic resin film and a standard white plate overlapped each other, and a spectral reflection spectrum was measured from the acrylic resin film side under conditions of 0° illumination for a reflection measurement, 45° circumferential light reception, standard light D65, and 10° field of view to determine the tristimulus values X, Y, and Z in the XYZ color system and determine the chromaticity coordinate (x, y) therefrom.

(Lightness (L* Value) of Acrylic Resin Film)

The acrylic resin film was stacked on a commercially available prism type retroreflective sheet (white) (Nikkalite CRG manufactured by Nippon Carbide Industries Co., Inc.) and a lightness (L* value) was measured from the acrylic resin film side under conditions of 0° illumination for a reflection measurement, 45° circumferential light reception, standard light D65, and 10° field of view.

(Chromaticity Coordinate (x, y) and Y Value of Acrylic Resin Film on White Reflective Sheet)

The acrylic resin film was stacked on a commercially available prism type retroreflective sheet (white) (Nikkalite CRG manufactured by Nippon Carbide Industries Co., Inc.) and a spectral reflection spectrum was measured from the acrylic resin film side under conditions of 0° illumination for a reflection measurement, 45° circumferential light reception, standard light D65, and 10° field of view to determine the tristimulus values X, Y, and Z in the XYZ color system and determine the chromaticity coordinate (x, y) therefrom.

(Weather Resistance of Acrylic Resin Film)

The acrylic resin film was subjected to accelerated exposure for 1000 hours under the condition of a method A of ISO 4892-2: 2013, and a color change of the acrylic resin film before and after the exposure was visually observed and determined according to the following criteria.

A: There is a change in color, but the color is maintained, and the chromaticity coordinate (x, y) is within the range A1.
B: Color fading is remarkable, and the chromaticity coordinate (x, y) is not within the range A1.

(Abbreviation)

MMA: Methyl methacrylate

n-BA: n-butyl acrylate

1,3-BD: 1,3-butylene glycol dimethacrylate

AMA: Allyl methacrylate

CHP: Cumene hydroperoxide

t-BH: t-butyl hydroperoxide

n-OM: n-octyl mercaptan

EDTA: disodium ethylenediamine tetraacetate

SFS: Sodium formaldehyde sulfoxylate (rongalite)

RS610NA: Polyoxyethylene alkyl ether sodium phosphate (Phosphanol RS610NA, manufactured by Toho Chemical Industry Co., Ltd.)

(Production of Rubber-Containing Polymer (A1-1))

In a container provided with a stirrer and a cooler, 8.5 parts of ion-exchanged water was charged, and a monomer component (m11-1) including 0.3 parts of MMA, 4.5 parts of n-BA, 0.2 parts of 1,3-BD, and 0.05 parts of AMA and 0.025 parts of CHP, which is a polymerization initiator, were added and mixed by stirring. 1.1 parts of RS610NA as an emulsifier was added to the container with stirring, and stirring was continued for 20 minutes to prepare an emulsion containing the monomer component (m11-1).

186.5 parts of ion-exchanged water was charged in a reaction vessel equipped with a cooler, and a temperature was raised to 70° C. A mixture prepared by adding 0.20 parts of SFS, 0.0001 parts of ferrous sulfate, and 0.0003 parts of EDTA to 5 parts of ion-exchanged water was put into a reaction vessel all at once. The emulsion containing the monomer component (m11-1) was added dropwise to the reaction vessel over 8 minutes with stirring under nitrogen. The reaction was continued for 15 minutes to obtain a polymer obtained from the monomer component (m11-1).

Subsequently, a monomer component (m11-2) including 1.5 parts of MMA, 22.5 parts of n-BA, 1.0 part of 1,3-BD, and 0.25 parts of AMA, and 0.016 parts of CHP, which is a polymerization initiator, were added to the reaction vessel over 90 minutes. The reaction was continued for 60 minutes to obtain a rubber polymer (Aa-1).

The Tg of the rubber polymer (Aa-1) was −47° C.

Subsequently, a monomer component (m13-1) including 6.0 parts of MMA, 4.0 parts of n-BA, and 0.08 parts of AMA, and 0.013 parts of CHP, which is a polymerization initiator, were added dropwise to the reaction vessel over 45 minutes. The reaction was continued for 60 minutes to obtain an intermediate polymer.

The Tg of the polymer including only the monomer component (m13-1) was 20° C.

Subsequently, a monomer component (m12-1) including 55.2 parts of MMA and 4.8 parts of n-BA, 0.22 parts of n-OM, which is a chain transfer agent, and 0.08 parts of t-BH, which is a polymerization initiator, were added dropwise to the reaction vessel over 140 minutes. The reaction was continued for 60 minutes to obtain latex containing the rubber-containing polymer (A1-1).

The Tg of the polymer formed only of the monomer component (m12-1) was 84° C.

The mass average particle size of the rubber-containing polymer (A1-1) in the latex was 0.12 μm.

The latex containing the rubber-containing polymer (A1-1) was filtered using a vibration type filtration device equipped with a stainless steel mesh (average opening 54 μm) as a filter medium. A filtrate was put into an aqueous solution containing 3 parts of calcium acetate to salt out a polymer. The polymer was washed with water, recovered, and then dried to obtain a powdery rubber-containing polymer (A1-1). A gel content of the rubber-containing polymer (A1-1) was 58%.

(Raw Material)

Thermoplastic polymer (A2-1): ACRYPET (registered trademark, the same applies below) MD manufactured by Mitsubishi Chemical Corporation, gel content 0%

Ultraviolet absorber: Benzotriazole ultraviolet absorber, ADEKA STAB LA-31RG, manufactured by ADEKA

Light Stabilizer (D-1): Hindered Amine Light Stabilizer, Chimassorb (registered trademark) 2020 FDL, manufactured by BASF

Antioxidant: Hindered phenolic antioxidant, Irganox 1076, manufactured by BASF

Fluorescent dye (B-1): DYMIC MBR D-77 Red manufactured by Dainichiseika Kogyo Co., Ltd.

Fluorescent dye (B-2): DYMIC MBR D-71 Yellow manufactured by Dainichiseika Kogyo Co., Ltd.

Colorant (C-1): DYMIC MBR 002 White manufactured by Dainichiseika Kogyo Co., Ltd.

Colorant (C-2): DYMIC MBR D-05 Yellow manufactured by Dainichiseika Kogyo Co., Ltd.

Colorant (C-3): DYMIC MBR 443 Yellow manufactured by Dainichiseika Kogyo Co., Ltd.

Colorant (C-4): DYMIC MBR 155 Red manufactured by Dainichiseika Kogyo Co., Ltd.

### Example 1

The ultraviolet absorber, the light stabilizer (D-1), the antioxidant, the fluorescent dye (B-1), the fluorescent dye (B-2), the colorant (C-1), and the colorant (C-2) were added in a mixing amount shown in Table 1, to the acrylic resin (A) including 80 parts of the rubber-containing polymer (A1-1) and 20 parts of the thermoplastic polymer (A2-1), and mixed using a henschel mixer to obtain an acrylic resin composition.

The acrylic resin composition was supplied to a degassing twin-screw kneading extruder (TEM-35B, manufactured by Toshiba Machine Co., Ltd.) heated to 240° C. and kneaded to obtain pellets of the acrylic resin composition.

The pellets of the acrylic resin composition were formed into a film using a 30 mmφ (diameter) non-vent screw type extruder (L/D=26) equipped with a 150 mm wide T die, under conditions of a cylinder temperature of 200° C. to 240° C., a T die temperature of 240° C., and a cooling roll temperature of 80° C. The acrylic resin film was wound around a paper tube with a winder to obtain a roll-shaped article of the acrylic resin film which was fluorescently colored, transparent, and has a thickness of 60 μm.

The results are shown in the table and figure below.

### Example 2

A roll-shaped article of the acrylic resin film was obtained in the same manner as in Example 1 except that the light stabilizer (D-1) was changed to 0.3 parts.

The results are shown in the table and figure below.

### Example 3

A roll-shaped article of the acrylic resin film was obtained in the same manner as in Example 1 except that the light stabilizer (D-1) was changed to 0.5 parts, and the mixing amount of the fluorescent dye (B-1), the fluorescent dye (B-2), the colorant (C-1), and the colorant (C-2) was set as shown in Table 1.

The results are shown in the table and figure below.

### Example 4

A roll-shaped article of the acrylic resin film was obtained in the same manner as in Example 1 except that the light stabilizer (D-1) was changed to 0.7 parts.

The results are shown in the table and figure below.

### Example 5

A roll-shaped article of the acrylic resin film was obtained in the same manner as in Example 1 except that the mixing amount of the light colorant (C-2) was set as shown in Table 1.

The results are shown in the table and figure below.

### Comparative Example 1

A roll-shaped article of the acrylic resin film was obtained in the same manner as in Example 1 except that the light stabilizer (D) was changed to 0.3 parts and the colorant (C-2) was not used.

The results are shown in the table and figure below.

### Example 6

A roll-shaped article of the acrylic resin film was obtained in the same manner as in Example 1 except that the rubber-containing polymer (A1-1) was changed to 60 parts, the thermoplastic polymer (A2-1) was changed to 40 parts, and the mixing amount of the light stabilizer (D-1) was set as shown in Table 1.

The results are shown in the table and figure below.

### Example 7 and Comparative Examples 2 and 3

A roll-shaped article of the acrylic resin film was obtained in the same manner as in Example 1 except that the ultraviolet absorber, the light stabilizer (D-1), the antioxidant, the fluorescent dye (B-1), the fluorescent dye (B-2), the colorant (C-3), and the colorant (C-4) were mixed in a mixing amount shown in Table 2, with the acrylic resin (A) including 60 parts of the rubber-containing polymer (A1-1) and 40 parts of the thermoplastic polymer (A2-1).

The results are shown in the table and figure below.

### Examples 8 to 10 and Comparative Example 4

A roll-shaped article of the acrylic resin film was obtained in the same manner as in Example 1 except that the ultraviolet absorber, the light stabilizer (D-1), the antioxidant, the fluorescent dye (B-1), the fluorescent dye (B-2), the colorant (C-1), the colorant (C-3), and the colorant (C-4) were mixed in a mixing amount shown in Table 2, with the acrylic resin (A) including 60 parts of the rubber-containing polymer (A1-1) and 40 parts of the thermoplastic polymer (A2-1).

The results are shown in the table and figure below.

### Example 11 and Comparative Examples 5 to 7

A roll-shaped article of the acrylic resin film was obtained in the same manner as in Example 1 except that the rubber-containing polymer (A1-1) was changed to 60 parts, the thermoplastic polymer (A2-1) was changed to 40 parts, and the mixing amount of the fluorescent dye (B-1), the fluorescent dye (B-2), the colorant (C-1), and the colorant (C-2) was set as shown in Table 2.

The results are shown in the table and figure below.

TABLE 1

| | | | Example | | | | | |
|---|---|---|---|---|---|---|---|---|
| | | | 1 | 2 | 3 | 4 | 5 | 6 |
| Mix (part(s)) | Rubber-containing polymer (A1-1) | | 80 | 80 | 80 | 80 | 80 | 60 |
| | Thermoplastic polymer (A2-1) | | 20 | 20 | 20 | 20 | 20 | 40 |
| | Ultraviolet absorber | | 1.88 | 1.88 | 1.88 | 1.88 | 1.88 | 1.88 |
| | Light stabilizer (D-1) | | 0.2 | 0.3 | 0.5 | 0.7 | 0.2 | 0.3 |
| | Antioxidant | | 0.1 | 0.1 | 0.1 | 0.1 | 0.1 | 0.1 |
| | Fluorescent dye (B-1) | | 0.25 | 0.25 | 0.31 | 0.25 | 0.25 | 0.25 |
| | Fluorescent dye (B-2) | | 0.30 | 0.30 | 0.38 | 0.30 | 0.30 | 0.30 |
| | Colorant (C-1) | | 0.80 | 0.80 | 1.00 | 0.80 | 0.80 | 0.80 |
| | Colorant (C-2) | | 2.00 | 2.00 | 2.50 | 2.00 | 3.00 | 2.00 |
| | Colorant (C-3) | | — | — | — | — | — | — |
| | Colorant (C-4) | | — | — | — | — | — | — |
| Transparency | Total light transmittance (%) | | 29.3 | 29.9 | 28.1 | 30.9 | 30.2 | 30.4 |
| | Haze (%) | | 11.6 | 10.3 | 11.1 | 10.1 | 8.8 | 9.1 |
| Acrylic resin film | L* value | | 36.62 | 36.31 | 38.27 | 37.12 | 37.06 | 36.40 |
| | Y value | | 16.7 | 16.8 | 21 | 17.1 | 16.4 | 16.7 |
| | Chromaticity coordinate | x | 0.646 | 0.645 | 0.655 | 0.644 | 0.646 | 0.646 |
| | | y | 0.346 | 0.347 | 0.338 | 0.349 | 0.347 | 0.348 |
| Acrylic resin film on | Y value | | 9.3 | 9.2 | 10.2 | 9.6 | 8.3 | 8.5 |
| white reflective sheet | Chromaticity coordinate | x | 0.635 | 0.635 | 0.643 | 0.633 | 0.636 | 0.636 |
| | | y | 0.350 | 0.350 | 0.344 | 0.353 | 0.351 | 0.352 |

| | | | | | | |
|---|---|---|---|---|---|---|
| Change in color of acrylic resin film after accelerated exposure | A | A | A | A | A | A |

TABLE 2

| | | | Example | | | | |
|---|---|---|---|---|---|---|---|
| | | | 7 | 8 | 9 | 10 | 11 |
| Mix (part(s)) | Rubber-containing polymer (A1-1) | | 60 | 60 | 60 | 60 | 60 |
| | Thermoplastic polymer (A2-1) | | 40 | 40 | 40 | 40 | 40 |
| | Ultraviolet absorber | | 1.88 | 1.88 | 1.88 | 1.88 | 1.88 |
| | Light stabilizer (D-1) | | 0.2 | 0.2 | 0.2 | 0.2 | 0.2 |
| | Antioxidant | | 0.1 | 0.1 | 0.1 | 0.1 | 0.1 |
| | Fluorescent dye (B-1) | | 0.25 | 0.25 | 0.25 | 0.25 | 0.10 |
| | Fluorescent dye (B-2) | | 0.30 | 0.30 | 0.30 | 0.30 | 0.50 |
| | Colorant (C-1) | | — | 0.80 | 0.40 | 0.80 | 0.40 |
| | Colorant (C-2) | | — | — | — | — | 1.00 |
| | Colorant (C-3) | | 0.96 | 0.24 | 0.96 | 0.96 | — |
| | Colorant (C-4) | | 0.45 | 0.11 | 0.45 | 0.45 | — |
| Transparency | Total light transmittance (%) | | 32.4 | 34.6 | 31.7 | 31.4 | 46.42 |
| | Haze (%) | | 19.7 | 23.1 | 22.2 | 22.2 | 11.03 |
| Acrylic resin film | L* value | | 46.18 | 50.30 | 47.21 | 47.43 | 45.04 |
| | Y value | | 22.7 | 26.7 | 23 | 22.6 | 26.1 |
| | Chromaticity coordinate | x | 0.638 | 0.628 | 0.636 | 0.636 | 0.618 |
| | | y | 0.351 | 0.347 | 0.349 | 0.348 | 0.373 |
| Acrylic resin film on | Y value | | 15.2 | 18.7 | 16.0 | 15.7 | 14.6 |
| white reflective sheet | Chromaticity coordinate | x | 0.628 | 0.619 | 0.625 | 0.625 | 0.609 |
| | | y | 0.356 | 0.350 | 0.353 | 0.352 | 0.376 |

| | | | | | |
|---|---|---|---|---|---|
| Change in color of acrylic resin film after accelerated exposure | A | A | A | A | A |

TABLE 3

| | | | Comparative Example | | | | | | |
|---|---|---|---|---|---|---|---|---|---|
| | | | 1 | 2 | 3 | 4 | 5 | 6 | 7 |
| Mix (part(s)) | Rubber-containing polymer (A1-1) | | 80 | 60 | 60 | 60 | 60 | 60 | 60 |
| | Thermoplastic polymer (A2-1) | | 20 | 40 | 40 | 40 | 40 | 40 | 40 |
| | Ultraviolet absorber | | 1.88 | 1.88 | 1.88 | 1.88 | 1.88 | 1.88 | 1.88 |
| | Light stabilizer (D-1) | | 0.3 | 0.2 | 0.2 | 0.2 | 0.2 | 0.2 | 0.2 |
| | Antioxidant | | 0.1 | 0.1 | 0.1 | 0.1 | 0.1 | 0.1 | 0.1 |
| | Fluorescent dye (B-1) | | 0.25 | 0.25 | 0.25 | 0.25 | 0.25 | 0.25 | 0.25 |
| | Fluorescent dye (B-2) | | 0.3 | 0.3 | 0.3 | 0.3 | 0.3 | 0.3 | 0.3 |
| | Colorant (C-1) | | 0.8 | — | — | 0.4 | 0.8 | 0.8 | 0.8 |
| | Colorant (C-2) | | — | — | — | — | 4 | 5 | 6 |
| | Colorant (C-3) | | — | 0.24 | 0.32 | 0.24 | — | — | — |
| | Colorant (C-4) | | — | 0.11 | 0.15 | 0.11 | — | — | — |
| Transparency | Total light transmittance (%) | | 37.1 | 35.2 | 35 | 35.6 | 29.18 | 29.08 | 27.49 |
| | Haze (%) | | 21.5 | 16.9 | 16.4 | 19.6 | 6.85 | 6.44 | 6.21 |
| Acrylic resin film | L* value | | 52.11 | 46.74 | 46.34 | 48.39 | 33.39 | 32.83 | 31.52 |
| | Y value | | 27.8 | 24.8 | 24.7 | 25.8 | 17.7 | 17.3 | 16.2 |
| | Chromaticity coordinate | x | 0.61 | 0.626 | 0.63 | 0.626 | 0.652 | 0.652 | 0.655 |
| | | y | 0.341 | 0.351 | 0.35 | 0.348 | 0.343 | 0.343 | 0.340 |
| Acrylic resin film on white | Y value | | 19.6 | 15.8 | 15.5 | 17.1 | 7.7 | 7.5 | 6.9 |
| reflective sheet | Chromaticity coordinate | x | 0.607 | 0.619 | 0.622 | 0.619 | 0.643 | 0.644 | 0.647 |
| | | y | 0.347 | 0.36 | 0.359 | 0.354 | 0.346 | 0.346 | 0.344 |

| | | | | | | | |
|---|---|---|---|---|---|---|---|
| Change in color of acrylic resin film after accelerated exposure | B | B | B | B | A | A | A |

TABLE 4

| | Xenon | | Total | | | |
|---|---|---|---|---|---|---|
| | exposure | | light | | Chromaticity | |
| | time | Haze | transmittance | Y | coordinate | |
| | (hr) | (%) | (%) | value | x | y |
| Example 1 | 0 | 11.6 | 29.3 | 9.33 | 0.635 | 0.350 |
| | 1000 | 8.0 | 60.4 | 15.71 | 0.566 | 0.419 |
| | 2000 | 7.8 | 67.1 | 17.60 | 0.540 | 0.443 |
| Example 5 | 0 | 9.1 | 30.4 | 8.54 | 0.636 | 0.352 |
| | 1000 | 6.5 | 57.7 | 13.47 | 0.574 | 0.413 |
| | 2000 | 9.2 | 64.0 | 15.25 | 0.551 | 0.436 |
| Example 6 | 0 | 10.3 | 29.9 | 9.17 | 0.635 | 0.350 |
| | 1000 | 6.7 | 63.7 | 16.32 | 0.556 | 0.429 |
| | 2000 | 6.5 | 69.4 | 17.65 | 0.532 | 0.450 |
| Example 7 | 0 | 19.1 | 31.3 | 14.55 | 0.628 | 0.354 |
| | 1000 | 12.1 | 46.0 | 15.01 | 0.595 | 0.381 |
| | 2000 | 9.9 | 51.7 | 13.8 | 0.570 | 0.392 |
| Example 8 | 0 | 23.1 | 34.6 | 17.1 | 0.619 | 0.354 |
| | 1000 | 14.7 | 59.7 | 22.72 | 0.550 | 0.393 |
| | 2000 | 12.2 | 67.8 | 23.15 | 0.507 | 0.412 |
| Example 9 | 0 | 21.5 | 30.9 | 15.14 | 0.625 | 0.352 |
| | 1000 | 14.4 | 45.5 | 15.42 | 0.588 | 0.380 |
| | 2000 | 12.7 | 50.2 | 14.69 | 0.564 | 0.388 |
| Example 10 | 0 | 22.2 | 31.4 | 16.01 | 0.625 | 0.353 |
| | 1000 | 17.0 | 43.6 | 15.86 | 0.592 | 0.376 |
| | 2000 | 14.5 | 48.2 | 14.96 | 0.573 | 0.388 |
| Comparative | 0 | 21.3 | 35.2 | 15.72 | 0.625 | 0.352 |
| Example 1 | 1000 | 12.5 | 76.2 | 31.57 | 0.491 | 0.408 |
| | 2000 | 11.4 | 83.8 | 35.14 | 0.429 | 0.416 |
| Comparative | 0 | 19.6 | 35.6 | 15.21 | 0.628 | 0.356 |
| Example 2 | 1000 | 10.7 | 64.2 | 21.08 | 0.533 | 0.403 |
| | 2000 | 9.7 | 71.5 | 21.56 | 0.490 | 0.419 |
| Comparative | 0 | 16.4 | 35.0 | 15.82 | 0.619 | 0.360 |
| Example 3 | 1000 | 8.4 | 63.4 | 18.9 | 0.546 | 0.405 |
| | 2000 | 7.5 | 70.7 | 20.04 | 0.499 | 0.424 |

The acrylic resin films obtained in Examples 1 to 11 had excellent visibility, maintained color thereof even after accelerated exposure, and had good weather resistance. In addition, the lightness (L* value) was high and the visibility was excellent.

The acrylic resin films obtained in Comparative Examples 1 to 4 had excellent visibility, but became colorless after accelerated exposure and were inferior in weather resistance. Furthermore, the acrylic resin films obtained in Comparative Examples 5 to 7 had a small change in color after accelerated exposure, but had low lightness (L* value) and were inferior in visibility.

### INDUSTRIAL APPLICABILITY

The acrylic resin film for a retroreflective sheet, which is one aspect of the present invention, is useful as a skin material for a retroreflective sheet.

### REFERENCE SIGNS LIST

10 Enclosed lens type retroreflective sheet
11 Binder layer
12 Spherical lens
13 Reflective film
14 Retroreflective element layer
15 Skin material
20 Capsule type retroreflective sheet
21 Binder layer
22 Spherical lens
23 Reflective film
24 Retroreflective element layer
25 Skin material
26 Connecting wall
27 Independent subdivision space
30 Prism type retroreflective sheet
31 Connecting wall
32 Support layer
33 Prism
34 Retroreflective element layer
35 Independent subdivision space

1. An acrylic resin film for a retroreflective sheet, comprising:
an acrylic resin composition that contains;
an acrylic resin (A),
a fluorescent dye (B), and
at least one colorant (C) selected from the group consisting of pigments and dyes (here, a fluorescent dye is excluded),
wherein a content of the colorant (C) is 1.0 to 4.0 parts by mass with respect to 100 parts by mass of the acrylic resin (A).

2. The acrylic resin film for a retroreflective sheet according to claim 1,
wherein the fluorescent dye (B) includes at least one selected from the group consisting of a thioxanthene dye, a thioindigoid dye, an anthraquinone dye, a benzoxazole coumarin dye, a perylene dye, a peryleneimide dye, a benzopyran dye, an anthracene dye, and an isoquinoline dye.

3. The acrylic resin film for a retroreflective sheet according to claim 1,
wherein a total of a content of the fluorescent dye (B) contained in the acrylic resin composition and the content of the colorant (C) contained in the acrylic resin composition is 1.5 to 10.0 parts by mass, with respect to 100 parts by mass of the acrylic resin (A).

4. The acrylic resin film for a retroreflective sheet according to claim 1,
wherein the acrylic resin composition further contains a light stabilizer (D).

5. The acrylic resin film for a retroreflective sheet according to claim 4,
wherein a content of the light stabilizer (D) contained in the acrylic resin composition is 0.1 to 3.0 parts by mass with respect to 100 parts by mass of the acrylic resin (A).

6. The acrylic resin film for a retroreflective sheet according to claim 1,
wherein the fluorescent dye (B) contains one or both of a yellow fluorescent dye and a red fluorescent dye.

7. The acrylic resin film for a retroreflective sheet according to claim 1,
wherein a chromaticity coordinate (x, y) in an XYZ color system is within a range surrounded by four points of (0.583, 0.416), (0.535, 0.400), (0.642, 0.305), and (0.692, 0.309).

8. The acrylic resin film for a retroreflective sheet according to claim 1,
wherein a Y value in an XYZ color system is 10 to 40.

9. The acrylic resin film for a retroreflective sheet according to claim 1, comprising: an acrylic resin composition,
wherein the content of the colorant (C) contained in the acrylic resin composition is 1.1 to 2.5 parts by mass with respect to 100 parts by mass of the acrylic resin (A).

10. The acrylic resin film for a retroreflective sheet according to claim 1,
wherein the acrylic resin film is a single layer film formed from the acrylic resin composition.

11. A retroreflective sheet comprising:
the acrylic resin film for a retroreflective sheet according to claim 1,
wherein a chromaticity coordinate (x, y) in an XYZ color system is within a range surrounded by four points of (0.583, 0.416), (0.535, 0.400), (0.642, 0.305), and (0.692, 0.309).

12. The retroreflective sheet according to claim 11, further comprising:
a retroreflective element layer,
wherein the retroreflective element layer includes a spherical lens or a prism.

13. An acrylic resin film for a retroreflective sheet, comprising:
an acrylic resin composition that contains;
an acrylic resin (A),
a fluorescent dye (B), and
at least one colorant (C) selected from the group consisting of pigments and dyes (here, a fluorescent dye is excluded),
wherein all of the fluorescent dye (B) and the colorant (C) are contained in a single layer.
